(19) United States
(12) Patent Application Publication
(10) Pub. No.: US 2023/0334595 A1
(43) Pub. Date: Oct. 19, 2023

(54) LOCATION-BASED SOCIAL APPLICATION

(71) Applicant: MeetNorth LLC, New York, NY (US)

(72) Inventor: Jacqueline Ann Berchielli, New York, NY (US)

(21) Appl. No.: 18/136,269

(22) Filed: Apr. 18, 2023

Related U.S. Application Data
(60) Provisional application No. 63/332,587, filed on Apr. 19, 2022.

(51) Int. Cl. G06Q 50/00; H04W 4/021; G06Q 30/0238; G06Q 30/0251; G06Q 30/0601; H04W 4/21

(52) U.S. Cl. CPC G06Q 50/01; G06Q 30/0238; G06Q 30/0261; G06Q 30/0641; H04W 4/021; H04W 4/21

(57) ABSTRACT

A location-based social application can execute on user devices, and can virtually check users of the user devices in to venues if location data indicates that the user devices are within boundaries associated with the venues. Venues can include public venues as well as private venues that members of private groups can check-in to via the social application. While users are checked-in to a venue via the social application, the users can view profile information associated with other users who are also checked-in to the venue, such as social goal information and social passwords indicating interests of the users. While the users are at the venue, the social application enables options by which the users can initiate virtual and/or in-person connections with other users at the venue. The social application can also allow users to buy drinks or other items for other users from the venue.

### RELATED APPLICATIONS

This U.S. Patent Application claims priority to provisional U.S. Pat. Application No. 63/332,587, entitled “LOCATION-BASED SOCIAL APPLICATION,” filed on Apr. 19, 2022, the entirety of which is incorporated herein by reference.

### TECHNICAL FIELD

The present disclosure relates to a social application that executes on mobile devices or other computing devices, and more particularly to a social application that facilitates social connections between users who are physically present at the same venue.

### BACKGROUND

Various social applications that execute on computing devices have been developed that allow users to meet other users, such as dating applications, networking applications, and other social applications. However, many existing social applications are focused on connecting users virtually through the social applications themselves, without the users actually being present at the same location and meeting in-person. Virtual interactions or meetings through such social applications can be relatively impersonal, and may be less likely to lead to meaningful or long-lasting relationships between users than in-person interactions.

Additionally, virtual interactions via many existing social applications can be frustrating for users, relative to in-person interactions. For example, although people who meet in-person can immediately respond to one another, users of many existing social applications may send messages to other users and then have to wait for an unknown period of time to see if and/or when the other users respond to the messages.

The example systems and methods described herein may be directed toward mitigating or overcoming one or more of the deficiencies described above.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example of a social application that executes on user devices, and that facilitates social connections between users of the social application.

FIG. 2 shows an example of the social application in a state that may have occurred before the state shown in FIG. 1.

FIG. 3 shows an example in which the social application displays a map in a user interface.

FIG. 4 shows an example of a user profile that can be displayed via the social application.

FIG. 5 shows an example of a virtual connection page of the social application.

FIG. 6 shows a flowchart illustrating an example process of using the social application.

FIG. 7 shows a flowchart illustrating an example process of a first user using the social application to buy a drink from a venue for a second user.

FIG. 8 shows an example in which users can participate in private groups via the social application.

FIG. 9 shows an example in which a server can transmit venue deal notifications to instances of the social application.

FIG. 10 shows an example of system architecture for a user device.

FIG. 11 shows an example of system architecture for a computing system associated with a server.

### DETAILED DESCRIPTION

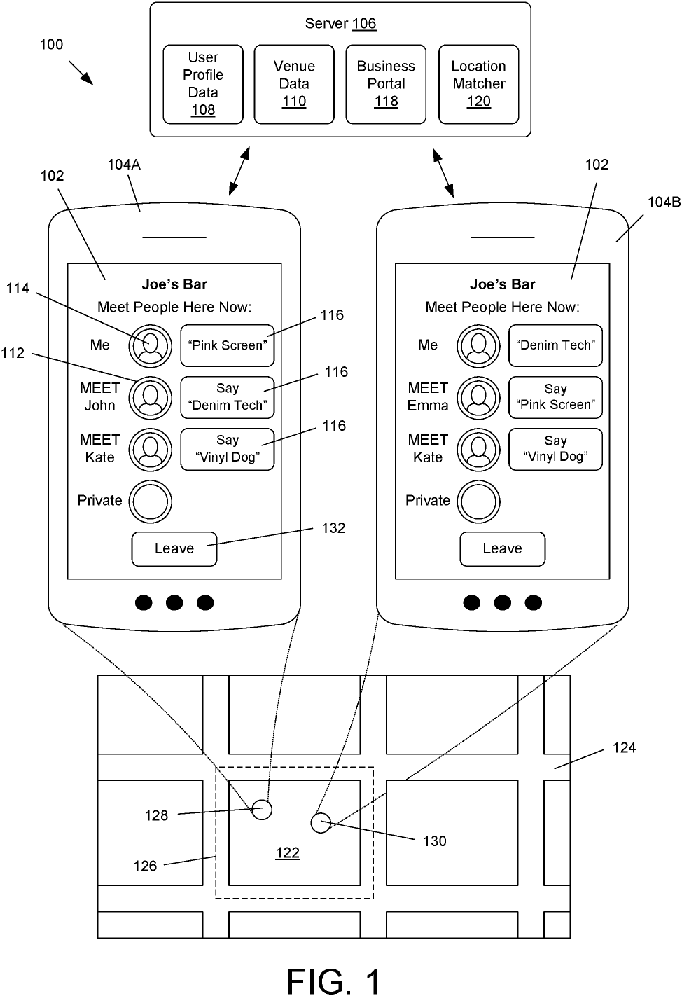

FIG. 1 shows an example 100 of a social application 102 that facilitates social connections between users of the social application 102. The social application 102 can be a mobile application or other type of computer-executable application that executes on user devices 104, such as an application that can be downloaded and installed on user devices 104. Instances of the social application 102 executing on the user devices 104 can communicate with a server 106 associated with the social application 102, for example by sending data to the server 106 and receiving data from the server 106. The server 106 can execute backend elements of the social application 102 as described herein. If geographical coordinates or other location data associated with different instances of the social application 102, executing on different user devices 104, indicate that the different user devices 104 are physically located at the same venue, the server 106 and/or the instances of the social application 102 can enable options for social interactions between corresponding users of the social application 102. The options for social interactions can include options for meeting users in-person and/or virtually, buying drinks or other items for other users, and/or other types of interactions. Accordingly, the social application 102 and/or server 106 can enable or facilitate virtual and/or in-person connections between users of the social application 102 if location data associated with corresponding user devices 104 indicate that the users are physically present at the same venue.

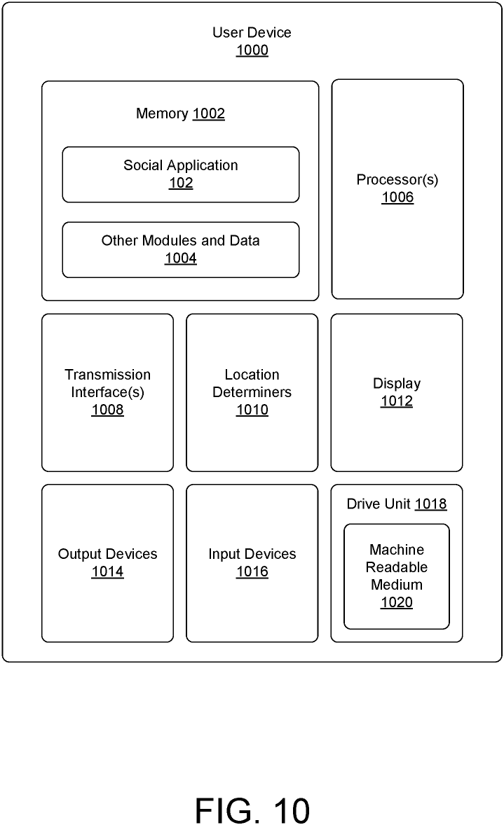

The user devices 104, such as user device 104A, user device 104B, and other user devices (collectively referred to herein as user devices 104) can be smartphones or other cellular phones, personal digital assistants (PDAs), tablet computers, smart watches, or other portable computing or communication devices. The user devices 104 can be mobile devices, such that users may transport the user devices 104 to different locations, including venues as described herein. An example of a system architecture for a user device is shown in FIG. 10, and is discussed further below with respect to that figure.

The user devices 104 can execute instances of the social application 102, as described above. The user devices 104 can have wireless communication interfaces that the instances of the social application 102 can use to communicate with the server 106. For example, the wireless communication interfaces of the user devices 104 can include cellular or other wireless interfaces based on fifth generation (5G) wireless networks, Long-Term Evolution (LTE) and other fourth generation (4G) wireless networks, Wi-Fi® networks, and/or other wireless data transmission technologies.

The user devices 104 can include Global Positioning System (GPS) components or other location-determining components that allow the user devices 104 and/or the instances of the social application 102 to determine geographical coordinates of locations of the user devices 104. In some examples, the user devices 104 can have other components that determine locations of the user devices 104 relative to beacons, other user devices 104, other computing devices, or other elements. For example, a user device may have Near-Field Communication (NFC) components that can exchange data with nearby compatible NFC elements, for instance to determine that the user device is within a threshold distance of a compatible NFC element and/or to exchange payment information with the compatible NFC element.

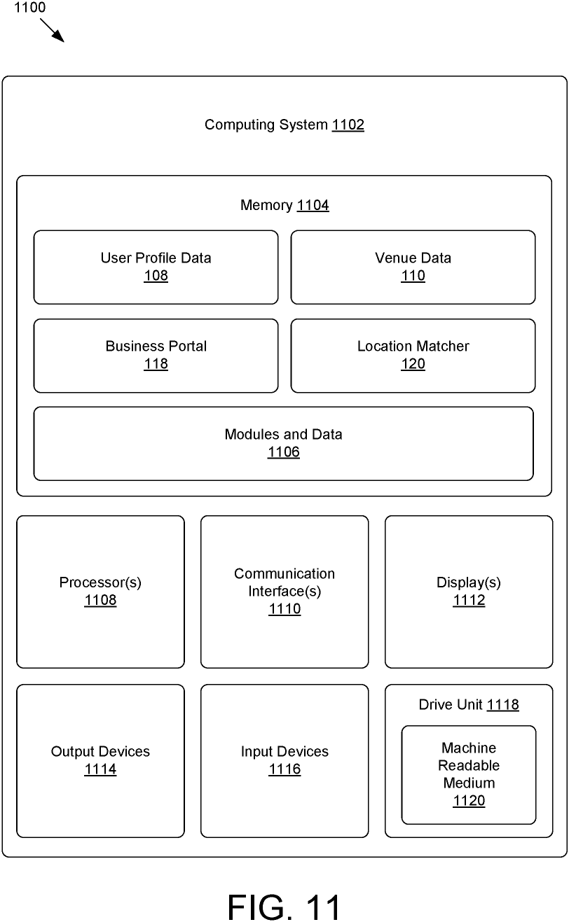

The server 106 can be cloud server, a remote computing platform, or other computing device, and can execute backend operations associated with the social application 102. In some examples, the server 106 can be a cloud computing environment or other computing environment that may host one or more instances of the server 106 and/or that may use multiple servers, virtual computing elements, containers, and/or other computing elements to execute backend operations associated with the social application 102. Although in some examples some operations associated with the social application 102 may be described herein as being performed locally by the social application 102 on a user device and other operations as being performed by the server 106, in other examples some operations may be executed by either the social application 102 or the server 106, and/or portions of some operations may be distributed between the social application 102 and the server 106. An example of a system architecture for the server 106 is shown in FIG. 11, and is discussed further below with respect to that figure.

Each user of the social application 102 can register for a user profile. The server 106 can store user profile data 108 associated with the user profiles of the users, such as user names, email addresses, phone numbers, and/or other contact information, account passwords, social goal information 112, profile pictures 114, social passwords 116, and/or other user profile information. In some examples, the social application 102 also store some types of user profile data 108, and/or access user profile data 108 from the server 106. For example, an instance of the social application 102 executing on a user device of a particular user may display a user interface that presents one or more types of user profile data 108 associated with other users, such as the social goal information 112, profile pictures 114, and social passwords 116 as shown in FIG. 1. However, other types of user profile data 108, such as contact information, account passwords, and/or other types of user profile data 108 for users can be kept private from other users, and may not be displayed via the social application 102 to other users.

The social goal information 112 of a user profile for a user can indicate one or more social goals of the user. For example, social goal information 112 can indicate that a user is interested in dating, networking, and/or making new friends.

The social passwords 116 associated with user profiles can be combinations of user-chosen words that may indicate interests of the users. For example, if a user collects vinyl records and also loves dogs, the user may select a social password of “vinyl dog.” The social password of a user can be used by another user as a passphrase to signal that the user is also a user of the social application 102, and/or as a conversation starter to establish a topic of conversation of interest to the user.

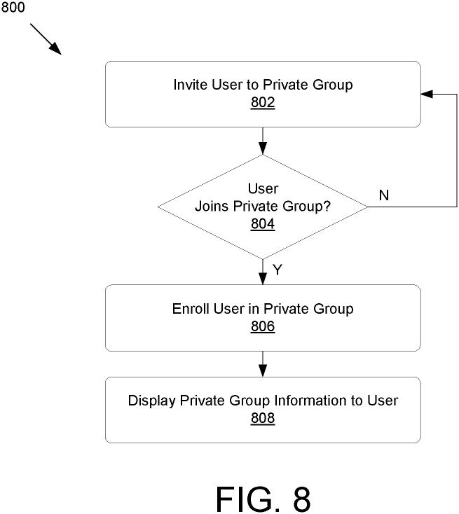

User profile data 108 associated with users may also indicate other types of information. As example, user profile data 108 for a user may indicate that the user is a member of a private group. As discussed further below with respect to FIG. 8, users may be invited to join private groups and/or can join private groups using corresponding authorization codes or other processes. Users in a private group may view data about, and/or check-in to, private venues associated with the private group through the social application 102. Users in a private group may also use the social application 102 to view user profile data 108 associated with other users who are also in the private group. In some examples, the social application 102 may provide notifications to users when other users in the same private group have checked-in to a venue.

As another example, user profile data 108 for users may indicate social circle information. Social circles can be set up via the social application 102 for groups of friends, clubs, organizations, sports teams, groups who share common interests, and/or any other groups. For example, a social circle can be established for members of a college student organization, and if a user of the social application 102 is a member of that college student organization and wants to join the social circle, the user may update user profile data 108 for the user through the social application 102 to indicate membership in the social circle. Users associated with a particular social circle can use the social application 102 to view user profile data 108 associated with other users who are also associated with the particular social circle. In some examples, the social application 102 may provide notifications to users when other users in the same social circle have checked-in to a venue.

As yet another example, the user profile data 108 for individual users may also indicate social comfort levels. For example, a user profile for a user may indicate whether the user would prefer to meet in-person right away, or would prefer introductions by messages via a virtual connection through the social application 102 before any in-person meetings. A user profile for a user may also indicate social distancing preferences regarding COVID-19 or other health concerns, such as whether the user is strict about COVID-19 social distancing and would thus prefer to meet other people in-person from a distance of at least six feet away.

As described further below, users who are located at the same venue can view each other’s social goal information 112, profile pictures 114, social passwords 116, social comfort levels and/or other profile information through the social application 102. In some examples, additional types of profile information associated with users can be displayed to other users via the social application 102. For instance, if a user is a member of a private group, the social application 102 may display information about other members of the same private group who are located at a venue. Similarly, if a user has joined one or more social circles, the social application 102 may display information about other users who are in those social circles.

Accordingly, users at a venue may use each other’s social goal information 112, profile pictures 114, social passwords 116, and/or other types of profile information displayed via the social application 102 to determine if they may have interests in common with other users at the venue, and/or are interested in meeting each other in-person at the venue. Users can also recognize each other in-person at the venue based on the profile pictures 114 of the users displayed via the social application 102. Users may also choose to use the social passwords 116 of other users, displayed via the social application 102, when introducing themselves to the other users in-person at the venue.

The server 106 can store venue data 110 associated with physical venues where users of the social application 102 can potentially meet in person. For example, venues may be bars, restaurants, clubs, sporting facilities, music venues, parks, and/or other types of venues and locations. The venue data 110 can indicate names of the venues, location data associated with the venues, such as addresses and/or geographical coordinates, contact information for the venues, and/or other information about the venues. In some examples, the social application 102 also store venue data 110, and/or access venue data from the server 106.

In some examples, venue data 110 can be added and/or edited by an entity that provides the social application 102. In other examples, the server 106 and/or the social application 102 can have a business portal 118 that can be used by operators of businesses to add or update venue data 110 associated with those businesses. The business portal 118 can, for example, be a website or an element of the social application 102 that can be used by operators of businesses. In some examples, the business portal 118 can also be used to designate venues owned or operated by businesses as public or private venues, to create or manage private groups associated with the businesses or corresponding venues, to send messages or notifications to users of the social application 102 who are associated with private groups managed via the business portal 118 and/or who have checked-in to venues via the social application 102, and/or to perform other operations as described herein.

In some examples, the business portal 118 can allow a business to edit one or more types of user profile data 108 associated with individual users. For instance, a business can use the business portal 118 to adjust tags or other data in user profile data 108 indicating which private groups individual users are invited to join and/or are authorized to join, approve enrollment of users into private groups associated with the business, disenroll users from private groups associated with the business, grant authorization for particular members of a private group to check-in to particular private venues associated with the business via the social application 102, grant authorization for particular members of a private group to view private venues associated with the business on a map via the social application 102, and/or perform other operations associated with managing membership of private groups and/or access to corresponding private venues.

The server 106 can also have a location matcher 120. The location matcher 120 can be configured to determine if locations of user devices 104 executing the social application 102 correspond with locations of venues, and/or to determine if locations of multiple user devices 104 executing the social application 102 are associated with the same venue. In some examples, the social application 102 may also have a location matcher or similar component that is configured to determine if the location of a user device executing the social application 102 is associated with a particular venue.

If the location matcher 120 determines that a user device executing an instance of the social application 102 is located at a particular venue, the server 106 and/or the instance of the social application 102 can enable features or options associated with that particular venue, as described further below. For instance, the instance of the social application 102 can enable features that allow a user to view profile information associated with other users who are also present at the venue, interact with the other users who are also present at the venue, receive notifications associated with the venue, and/or other features associated with the venue. The social application 102 may, in some examples, enable such features in association with a particular venue if a user has provided user input indicating that the user is visiting the venue and wants to engage with other users of the social application 102 at the venue. Accordingly, the social application 102 may, in some examples, not enable such features if the user is at or near the venue but is not intending to use features of the social application 102 in association with the venue.

For example, FIG. 1 shows the location of a venue 122 on a map 124. The venue data 110 associated with the venue 122 may indicate an address and/or geographical coordinates of the venue 122, as well as boundaries 126 associated with the venue 122. The boundaries 126 can, for example, be a defined geofence that surrounds the venue 122, an area that extends for a defined radius around coordinates associated with the venue 122, or other types of border or boundaries associated with the venue 122. The server 106 can receive first coordinates 128 of user device 104A and second coordinates 130 of user device 104B from instances of the social application 102 executing on those user devices 104, and can determine that the first coordinates 128 of user device 104A and the second coordinates 130 of user device 104B are within the boundaries 126 associated with the venue 122. If users of user device 104A and user device 104B have used corresponding instances of the social application 102 to indicate that the users want to use the social application 102 in association with the venue 122, the instances of the social application 102 can “check-in” the users to the venue 122 in response to determinations that the user devices 104 are within the boundaries 126 associated with the venue 122. The social application 102 can also enable features that allow the users of user device 104A and user device 104B to engage with each other, and/or other users, while the users are present at the venue 122.

As a non-limiting example, user device 104A may be associated with a user named Emma, and user device 104B may be associated with a user named John. The venue 122 may be an establishment known as Joe’s Bar, and user device 104A and user device 104B associated with Emma and John may both be located within the boundaries 126 associated with Joe’s Bar as shown in FIG. 1. Emma and John may have provided user input to the social application 102 indicating that they were planning to visit Joe’s Bar, and the social application 102 can have enabled features once the server 106 or the social application 102 determined that the user devices 104 of Emma and Joe were physically within the boundaries 126 associated with Joe’s Bar. Other users of the social application 102 may also be present at Joe’s Bar, such as a user named Kate and a user with a user profile set to private, as shown in FIG. 1.

An instance the social application 102 executing on a user device associated with a particular user can display user profile information associated with that particular user, as well as user profile information associated with the other users who are also present at the venue 122. For example, the social application 102 on Emma’s user device 104A can show a version of Emma’s profile information, including Emma’s profile picture, Emma’s social goals, and Emma’s social password of “Pink Screen.” The social application 102 on Emma’s user device 104A can also show profile information about John, Kate, and other users of the social application 102 who are at Joe’s Bar. For instance, the social application 102 can display John’s profile picture, John’s social goals, and John’s social password of “Denim Tech,” as shown in FIG. 1. Emma may be able to select John’s profile in the social application 102 to view other information about John’s user profile. In some examples, the social application 102 may also display additional information if Emma and John are both associated with the same social circle, or are both part of the same private group. If Emma would like to meet John in-person at Joe’s Bar, Emma can find John at Joe’s Bar by looking around and identifying John in-person based on John’s profile picture displayed in the social application 102. Emma may choose to use John’s social password of “Denim Tech,” displayed in the social application 102, to introduce herself when meeting John in-person.

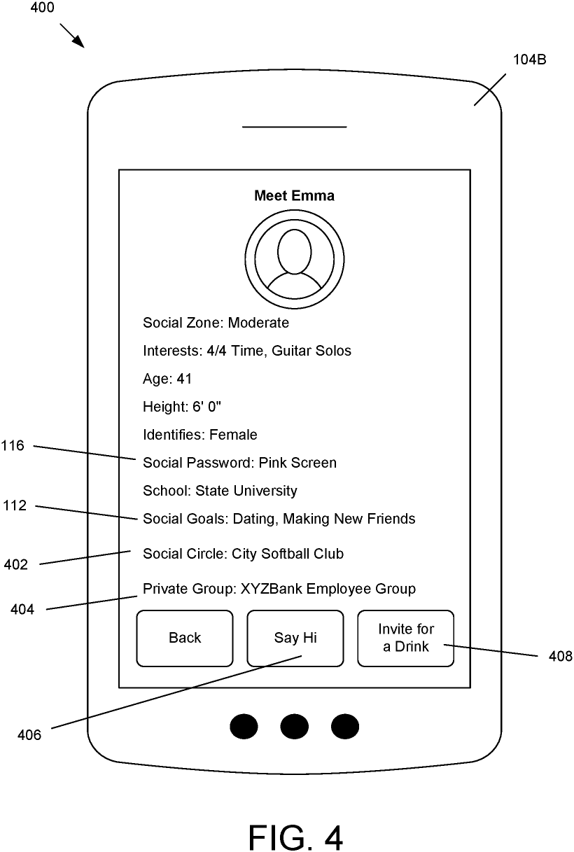

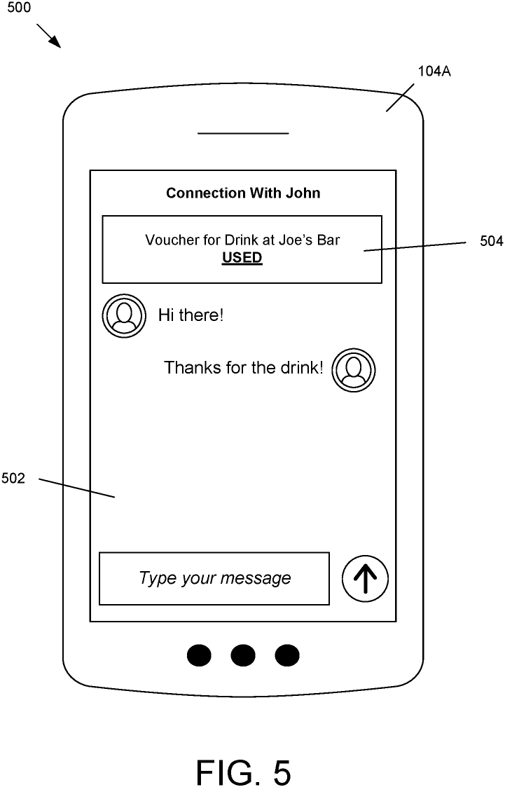

Although user profile information displayed in the social application 102 can allow users to meet in-person as discussed above, the social application 102 can also establish virtual connections between users who are located at the same venue. Virtual connections can allow users to exchange messages or other data, for instance if the users are not yet comfortable meeting or talking in-person. In some examples, a user can select the user profile of another user via the social application 102, and can select that user’s social password or another option to send a virtual introduction to the user via the social application 102, as discussed further below with respect to FIG. 4. If the other user responds, the social application 102 can establish a virtual connection between the users, such that the users can send messages to each other via the social application 102 as discussed further below with respect to FIG. 5.

For example, if Emma and John are both at Joe’s Bar as shown in the example of FIG. 1, but Emma is not yet comfortable meeting John in-person, Emma can instead choose to use the social application 102 to establish a virtual connection with John. Although John and Emma are both physically present at Joe’s Bar, they may exchange messages via the social application 102 after establishing a virtual connection, before choosing whether or not to actually meet and talk to each other in-person. If John and Emma have already met in-person, they can also choose to establish a virtual connection via the social application 102, such that they have the option to continue to keep in touch via the social application 102 after they leave Joe’s Bar.

As shown in FIG. 1, a user may optionally set a corresponding user profile to private. If a user’s profile is set to private while at a venue, the social application 102 may allow the user to view profile of other users at the venue. However, in some examples, the social application 102 may disable options for connecting with other users, and/or the user’s profile information may be inaccessible to other users of the social application 102, while the user’s profile is set to private.

Social goal information 112 of users at a venue can be visible to other users via the social application 102, such that users can determine whether other users are interested in the same types of social interactions. In some examples, the social goal information 112 of users can be displayed as color-coded indicia, or other types of indicia, in a user interface of the social application 102. For instance, a ring or border around a user’s profile picture can be colored a first color if the user is interested in dating, a second color if the user is interested in networking, or a third color if the user is interested in making new friends. If the user has multiple social goals, for instance to make new friends and also meet people for networking, the ring or border around the profile picture may be displayed as a pie chart with segments of different colors that correspond to the user’s different social goals. In other examples, indicia of one or more social goals of a user can be displayed as text, bar charts, icons, colors, shades of colors, or any other type of visual indicia.

The visual indicia of social goals displayed via the social application 102 may, in some examples, indicate relative importance levels that the user has placed on different social goals. As a non-limiting example, if the user is primarily interested in dating, and has a lower interest in networking, the visual indicia may show a color associated with the dating social goal as a darker shade than the shade of another color associated with the networking social goal, blink a dating social goal indicator at a faster rate than a networking social goal indicator, or otherwise indicate the user’s higher level of interest in the dating social goal relative to the networking social goal.

Similar to visual indicia of social goal information 112, the user interface of the social application 102 can also display other indicia of users who are part of private groups and/or social circles. For example, if a user is associated with a private group or a social circle, and other users who have checked-in to a venue are associated with the same private group or social circle, the social application 102 may display text, icons, colors, and/or other indicia identifying the private group or social circle in association with profile data for the other users.

In some examples, if users at a venue have established virtual connections via the social application 102, the social application 102 can present options for the users to purchase items for the other users from the venue via the social application 102. A user at the venue can, for example, choose to purchase items for other users at the venue, set a budget for purchases of items for other users, select the items for the other users or enable the other users to select the items, and pay for the items via the social application 102. The social application 102 and/or the server 106 can, in some examples, interact with a point-of-sale (POS) system and/or ordering system associated with the venue, in order to implement purchases from the venue by users of the social application 102 as discussed further below.

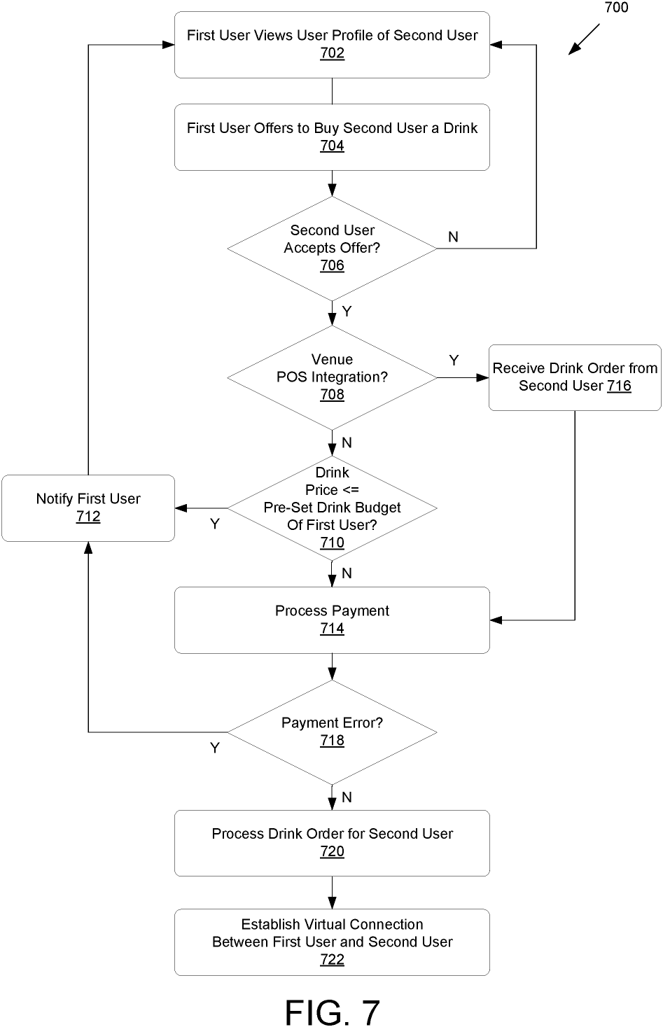

As an example, if John and Emma are both at Joe’s Bar as discussed above, John may select an option in the social application 102 on John’s user device 104B to buy a drink for Emma from Joe’s Bar. The social application 102 on Emma’s user device 104A may respond by presenting an option for Emma to accept or decline John’s offer. In some examples, the social application 102 may also present a drink menu from Joe’s Bar to Emma and/or John, such that one of the users can select a drink to order from the menu. The social application 102 on John’s user device 104B and/or the server 106 may interact with a POS system of Joe’s Bar to initiate an order of the selected drink, and to pay for the drink using John’s stored payment information. In other examples, if Emma accepts John’s offer, the social application 102 on John’s user device 104B and/or the server 106 may interact with the POS system of Joe’s Bar to order and pay for a drink voucher valued at up to a maximum limit set by John and stored in the user profile data 108. In these examples, the drink voucher can be displayed via the social application 102 on Emma’s user device 104A. The drink voucher may have a quick response (QR) code, barcode, or other code, and Emma can show the drink voucher to a bartender or other staff member at Joe’s Bar to redeem the drink voucher for a drink. Other examples of buying drinks or other items via the social application 102 are discussed further below with respect to FIG. 4, FIG. 5, and FIG. 7.

When a user chooses to leave a venue that the user has checked-in to via the social application 102, the user can select a leave option 132 via the social application 102. Selection of the leave option 132 can cause the social application 102 to check the user out of the venue, and disable interactions with other users at the venue that the user has not already established a virtual connection with. For instance, the social application 102 can allow users to establish virtual connections with one another if the users are checked-in to the same venue via the social application 102, but may not provide options to establish virtual connections with other users if the users are not yet, or are no longer, checked-in to the same venue. In some examples, the social application 102 and/or the server 106 may also automatically check a user out of a venue, and/or disable interactions with other users at the venue, if location data indicates that the user’s user device has departed boundaries associated with the venue.

In some examples, any virtual connections that were established between users of the social application 102 while the users were at a venue may persist in the social application 102 after users leave the venue. Accordingly, the social application 102 can facilitate communications between users after the users leave a venue where they initially met and/or established the virtual connection via the social application 102.

As discussed above, in some examples an instance of the social application 102 executing on a user device may disable options to connect with other users until the user device is physically located within the boundaries of a venue. However, users of the social application 102 may in some examples view at least some information about other users who are present at a venue prior to the user choosing to visit that venue, or arriving at the venue.

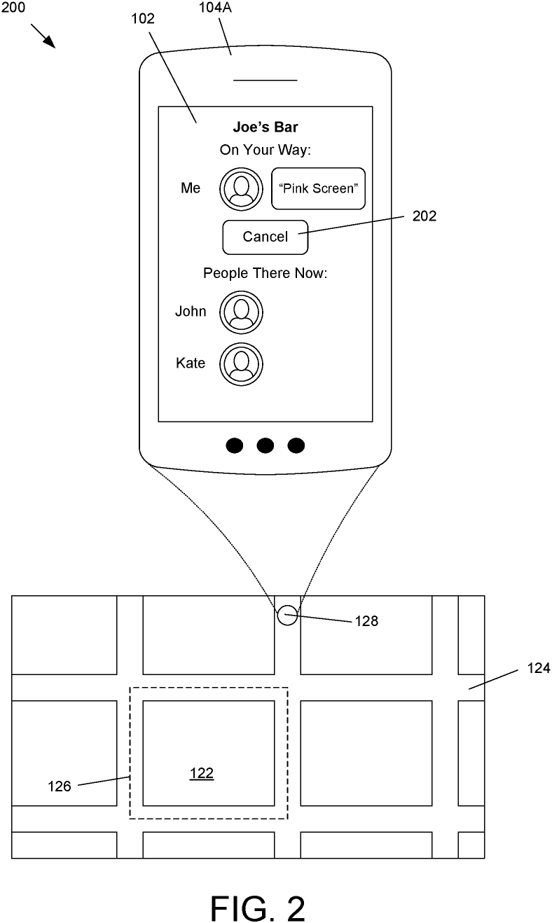

For example, FIG. 2 shows an example 200 of the social application 102 in a state that may have occurred before the state shown in FIG. 1. In example 200, the user device 104A associated with Emma may not yet be present within the boundaries 126 associated with Joe’s Bar. However, Emma may have used the social application 102 to search for Joe’s Bar. The search may cause the social application 102 to display a list of users who are currently checked-in at Joe’s Bar, although the social application 102 may disable options for establishing connections with those users because user device 104A is not within the boundaries 126 of Joe’s Bar. If Emma decides to visit Joe’s Bar, Emma may select an option in the social application 102 to indicate that she is en route to Joe’s Bar. Based on selection of that option, the social application 102 may track the location of the user device 104A and/or provide corresponding coordinates of user device 104A to the server 106. Accordingly, once the social application 102 and/or the server 106 determine from such coordinates that user device 104A has reached a location within the boundaries 126 associated with Joe’s Bar, the social application 102 and/or the server 106 can enable features that allow Emma to interact with the other users at Joe’s Bar via the social application 102 as discussed above with respect to FIG. 1.

If a user has indicated that they are on the way to a particular venue, but later changes their mind, the user may select a cancel option 202 as shown in FIG. 2 to indicate that the user is no longer on the way to the venue. Accordingly, in some examples, the social application 102 may stop tracking the location of the user device and/or providing corresponding coordinates to the server 106 in response to a user selection of the cancel option 202.

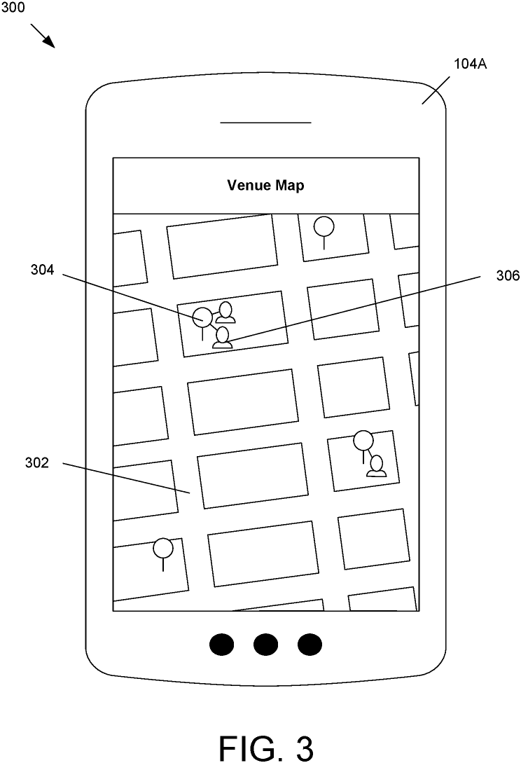

FIG. 3 shows an example 300 in which the social application 102 displays a map 302 in a user interface. In some examples, the map 302 can be similar to map 124 shown in FIG. 1 and FIG. 2. The map 302 displayed in the user interface can allow a user of the social application 102 to search for venues. The map 302 can also allow a user of the social application 102 to select individual venues, for instance to view information about the venues and/or at least some information about other users of the social application 102 who are currently checked-in to those venues via the social application 102. As discussed above with respect to FIG. 2, if the user chooses to visit a particular venue, the user can select an option in the social application 102 to indicate that the user is on the way to that venue, and can virtually check-in to the venue via the social application 102 once the user’s user device is physically present within boundaries associated with the venue.

For example, the map 302 can be a map of a city overlaid with venue icons 304, such as pins, icons, or other indicia indicating locations of venues. In some examples, sizes, colors, shapes, and/or other visual indicia associated with the venue icons 304 may reflect a number of users who are currently checked-in to those venues. For instance, a venue icon for a venue that has a large number of checked-in users may be displayed with a larger circle than a venue icon for another venue that has a smaller number of checked-in users.

In other examples, sizes, colors, shapes, and/or other visual indicia associated with venue icons 304 may indicate whether corresponding venues are public venues, or are private venues associated with one or more private groups of which the user is a member. As an example, if a user of user device 104A is a member of a private group within the social application 102, the map 302 shown in the social application 102 on user device 104A may use blue venue icons 304 to display public venues that any user may check-in to via the social application 102, and use green venue icons 304 to display private venues that the user and other members of the private group can check-in to via the social application 102. In this example, if a user not part of a private group, the social application 102 may omit venue icons 304 associated with private groups from the map 302.

If a user is associated with a private group or a social circle, the map 302 may also display user icons 306 of other users who are associated with that private group or social circle. Although as discussed above the user may not use the social application 102 to interact with other users until the user’s user device is within the boundaries of a venue where those users are checked-in, the map 302 may indicate that other users in a private group or social circle are currently checked-in to particular venues as shown in FIG. 3. Additionally, as discussed above, a user may also select a venue on the map 302 to view information about users who are checked-in to that venue, including users who may not be part of the same private group or social circle.

In some examples, the social application 102 can provide notifications of featured and/or suggested venues. For example, a particular venue may be designed as a featured venue on a particular day. The featured venue may be highlighted in the map 302, and/or the social application 102 may display notifications to users of user devices 104 associated with the featured venue, such that users may be more likely to choose to visit and gather at the featured venue. As another example, the social application 102 may suggest venues for users based on user interests indicated in user profile data 108 aligning with attributes of the venues and/or user interests of other users who are already currently checked-in to those venues.

FIG. 4 shows an example 400 of a user profile that can be displayed via the social application 102. In example 400, a user named John may be using user device 104B shown in FIG. 1 to view user profile information with another user named Emma, and user devices 104 of both John and Emma may be located within the boundaries 126 associated with Joe’s Bar as discussed above. John may be able to view Emma’s profile information by selecting Emma’s name or profile picture from the user interface view shown in FIG. 1. As shown in FIG. 4, the social application 102 can display some types of user profile data 108 associated with Emma’s profile, such as Emma’s name, profile picture, social goal information 112, social password 116, and/or other user profile information.

In some examples, the social application 102 may also display social circle information 402 and/or private group information 404 about Emma. For example, if John and Emma are both in the same softball club in their city and have joined a corresponding social circle via the social application 102, the social application 102 may identify the social circle shared by John and Emma when John views Emma’s profile information as shown in FIG. 4. The social application 102 may similarly highlight Emma’s profile in the views shown in FIG. 1 and FIG. 2 to indicate to John that another member of one of his social circles is at Joe’s Bar. Similarly, if John and Emma are both employed by “XYZBank” and have joined a private group for employees sponsored by “XYZBank” via the social application 102, the social application 102 may identify the private group shared by John and Emma when John views Emma’s profile information as shown in FIG. 4. The social application 102 may similarly highlight Emma’s profile in the views shown in FIG. 1 and FIG. 2 to indicate to John that another employee of “XYZBank” is at Joe’s Bar. In some examples, the social application 104 may refrain from displaying social circle information 402 and/or private group information 404 about Emma to John if John is not in the same social circle and/or private group as Emma.

When John view’s Emma’s profile information as shown in FIG. 4, the social application 102 can also display user-selectable options that John can select to initiate a potential virtual connection with Emma. For example, the profile page shown in FIG. 4 can display a “Say Hi” option 406. If John selects the “Say Hi” option 406, a corresponding notification can be displayed via the social application 102 on Emma’s user device 104A. Emma can respond by selecting an option to “Say Hi” back to John, by selecting an option to decline to respond, or by ignoring the notification. If Emma does select an option to “Say Hi” back to John, the social application 102 and/or the server 106 can establish a virtual connection between Emma and John, such that Emma and John can exchange messages in association with the virtual connection as discussed further below with respect to FIG. 5.

As another example, the profile page shown in FIG. 4 can display an “Invite for a Drink” option 408. If John selects the “Invite for a Drink” option 408, a corresponding notification indicating that John has offered to buy Emma a drink can be displayed via the social application 102 on Emma’s user device 104A. Emma can respond by selecting an option to accept the drink offer from John, by selecting an option to decline the drink offer, or by ignoring the drink offer. If Emma provides user input to accept the drink offer, the social application 102 and/or the server 106 can initiate a process by which John buys a drink for Emma from Joe’s Bar.

In some examples, if Emma accepts John’s drink offer, the social application 102 may display a virtual drink menu from Joe’s Bar, and Emma can use the virtual drink menu to order a drink in association with John’s drink offer. In some of these examples, the social application 102 may be integrated with a virtual POS system used by Joe’s Bar, such as Toast, Square, or any other POS that can be displayed via a user device. In these examples, the drink menu may be displayed via a user interface of the virtual POS system displayed via the social application 102 or a web browser on Emma’s user device 104A. The POS system can accept Emma’s drink order via user input from Emma on user device 104A, and the POS system can use stored payment information associated with John to bill John for Emma’s selected drink order. The operator of the social application 102 and/or server 106 may receive, from the POS system or from Joe’s Bar, a portion of the proceeds from drinks purchased from Joe’s Bar via the “Invite for a Drink” option 408.

In other examples, the social application 102 may display a virtual drink menu for drinks available from Joe’s Bar, and use stored payment information associated with John to bill John for a drink order selected by Emma via the social application 102. The social application 102 or server 106 may separately place a corresponding drink order on Emma’s behalf via a POS system used by Joe’s Bar. For instance, the server 106 may use an application programming interface (API) associated with the POS system to place the drink order via the POS system. In these examples, the operator of the social application 102 may charge John a processing fee or other surcharge above the cost of the ordered drink charged by the POS system. For instance, if the POS system used by Joe’s Bar charges $5.00 for the selected drink, the social application 102 may charge John $6.00 for the ordered drink, and re-place a $5.00 order for the drink via the POS system to account for a $1.00 processing fee.

In still other examples, if Emma accepts John’s drink offer, a corresponding payment based on stored payment information associated with John in the user profile data 108 or a third-party payment processor can be processed. If the payment using the stored payment information is successful, the social application 102 on Emma’s user device 104A can display a drink voucher that is valued at up to the value of the payment The drink voucher can be a QR code, barcode, numerical code, text code, or other code or drink voucher identifier. Emma can show the drink voucher to a bartender or other staff member at Joe’s Bar, such that Emma can redeem the drink voucher for a drink of Emma’s choosing that is valued at up to the value associated with the drink voucher. In some examples, when the drink voucher is redeemed at Joe’s Bar, a POS system or other system at Joe’s Bar can communicate with the server 106 to mark the drink voucher as having been redeemed.

If Emma accepts John’s drink offer initiated via the “Invite for a Drink” option 408, the social application 102 and/or the server 106 can establish a virtual connection between Emma and John, such that Emma and John can exchange messages in association with the virtual connection as discussed further below with respect to FIG. 5. In some examples, the virtual connection between Emma and John may be established after Emma accepts the drink offer, but before Emma selects a drink or redeems a corresponding drink voucher with the venue. However, in other examples, the virtual connection between Emma and John may be established via the social application 102 and/or the server 106 once Emma selects a drink or redeems a corresponding drink voucher with the venue.

In some examples, John can have entered or edited payment information prior to initiating the drink offer, or the social application 102 can prompt John to enter such payment information after John selects the “Invite for a Drink” option 408. John can also have set a maximum drink budget value in the user profile data 108, such that the social application 102, server 106, POS system, or third-party payment processor can use John’s stored payment information to charge up to the maximum drink budget value in response to selection of the “Invite for a Drink” option 408. Another example of a user buying another user a drink via the “Invite for a Drink” option 408 is discussed further below with respect to FIG. 7.

As discussed above, the “Say Hi” option 406 and “Invite for a Drink” option 408 may be visible and selectable to John on Emma’s profile page, via the instance of the social application 102 on John’s user device 104B, if the user devices 104 of both Emma and John are both located at Joe’s Bar and Emma and John have both checked-in to Joe’s Bar via the social application 102. For example, if Emma is at Joe’s Bar, but John is not at Joe’s Bar, John may be able to view some portions of Emma’s profile, but the “Say Hi” option 406 and the “Invite for a Drink” option 408 may be absent or non-selectable to John on Emma’s profile page because John is not at the same venue as Emma.

Additionally, if John has selected one of the “Say Hi” option 406 or the “Invite for a Drink” option 408 on Emma’s profile, the selected option may become grayed-out or non-selectable until Emma responds to a corresponding notification, or a notification time period of an hour or another period of time expires. For instance, if John has offered to buy Emma a drink via the “Invite for a Drink” option 408, but Emma has not yet responded, John may be unable to select the “Invite for a Drink” option 408 on Emma’s profile again. In some examples, if Emma declines a drink offer from John, the “Invite for a Drink” option 408 can become visible and/or selectable again. However, if Emma declines drink offers from John more than one time, two times, three times, or any other threshold amount, the “Invite for a Drink” option 408 can become non-selectable for John on Emma’s profile page permanently, for the rest of the day, or another period of time.

In some examples, the “Invite for a Drink” option 408 may be visible on user profiles for users who are present at, and have checked-in to, a venue that has an agreement with the provider of the social application 102 and/or server 106. For example, while Joe’s Bar may have an agreement and/or POS system integration with the server 106, another venue may not. At such a venue, the “Say Hi” option 406 may be available on user profile pages for users present at that venue, but the “Invite for a Drink” option 408 may be absent or non-selectable. In these examples, owners or operators of venues can use the business portal 118 described above to enter information about the venues, determine which options are selectable by users of the social application 102 who are checked-in to the venues, enter POS system integration information, and/or otherwise edit settings indicating how the social application 102 operates in association with the venues and/or displays information associated with the venues.

In some examples, options similar to the “Invite for a Drink” option 408 can be displayed for purchasing food or other items at associated venues. For instance, if users are checked-in to a venue that sells ice cream, a similar “Invite for Ice Cream” option may be displayed on a user profile page instead of, or in addition to, the “Invite for a Drink” option 408, such that a user can offer to buy ice cream for another user at the venue.

FIG. 5 shows an example 500 of a virtual connection page 502 of the social application 102. As discussed above, users who are present at the same venue and have checked-in to the venue can establish a virtual connection via the social application 102, such that the users can exchange messages via the social application 102 while the users are still at the venue and/or have left the venue. For instance, users John and Emma, discussed in the examples above, can be present at a venue named Joe’s Bar, and can have checked-in to Joe’s Bar via the social application 102. The social application 102 and/or the server 106 can establish a virtual connection between Emma and John, for instance because one of the users selected the “Say Hi′ option 406 and the other user selected an option to “Say Hi” back, or because one of the users selected the “Invite for a Drink” option 408 and the other user accepted the corresponding drink offer. The virtual connection page 502 can allow the users to exchange messages, as shown in FIG. 5.

As shown in FIG. 5, a drink voucher 504 associated with the virtual connection can be displayed on the corresponding virtual connection page 502. For example, if John bought a drink voucher from Joe’s Bar for Emma via the social application 102, the drink voucher can be displayed on the virtual connection page 502 associated with the connection between John and Emma. The drink voucher 504 can indicate whether the drink voucher 504 has been redeemed or not. For instance, although FIG. 5 shows the drink voucher 504 in a used state, if the drink voucher 504 was not yet used, Emma could select the drink voucher 504 via the virtual connection page 502 to redeem the drink voucher 504 with Joe’s Bar. In some examples, the virtual connection page 502 may not permit messaging between John and Emma until Emma redeems the drink voucher 504. In other examples, the virtual connection page 502 may permit messaging between John and Emma once Emma initially accepts the drink offer from John, regardless of whether Emma has redeemed the drink voucher 504.

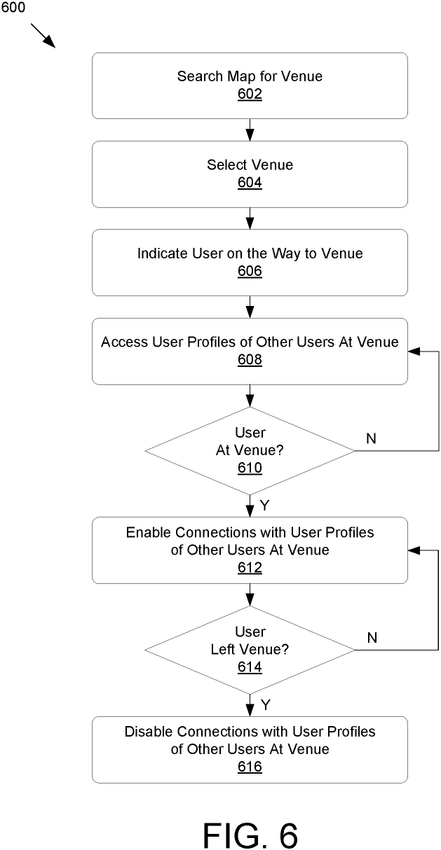

FIG. 6 shows a flowchart illustrating an example process 600 of using the social application 102. The process 600 can reflect use of the social application 102 by a particular user, via a user device of the user. The user can have a user profile with the social application 102, such that corresponding user profile data 108 is stored in the social application 102 and/or at the server 106.

At block 602, the user can use the social application 102 to search for a venue on a map. For example, as discussed above with respect to FIG. 3, the social application 102 can display a map of a city overlaid with venue icons 304 associated with venues. The user can select a venue icon associated with a venue to view information about the venue, including in some examples names, profile pictures, and/or other user profile information of other users who are currently checked-in to that venue via the social application 102. In some examples, the social application 102 can display featured and/or suggested venues at block 602. The social application 102 may also, or alternatively, display a list of venues, display categories of venues, allow the user to search for venues, and/or otherwise view possible venues that the user may choose to visit. In some examples, the map displayed via the social application 102 may also display user icons 306 associated with other users who are in the same private group and/or social circle as the particular user, such that the particular user may choose to view information about venues where other users in the same private group and/or social circle are checked-in via the social application 102.

At block 604, the user can select a particular venue via the social application 102, for instance from a map displayed while the user is searching for a venue at block 602. At block 606, the user can select an option to indicate that the user plans to visit the selected venue, and the social application 102 can mark the user as “on the way” to the selected venue. The social application 102 initiate a process to track the location of the user device, such that the social application 102 and/or the location matcher 120 of the server 106 can determine when the location of the user device changes to a location that is within the boundaries of the selected venue. For example, user selection of an option indicating that the user is “on the way” to the selected venue can cause the instance of the social application 102 executing on the user device of the user to provide geographical coordinates or other location data to the server 106.

At block 608, the social application 102 can enable options for the user to view user profile information of other users at the venue, while the user is en route to the venue but has not yet reached the venue. At block 608, the social application 102 can, however, disable options for the user to connect with, or otherwise interact with, those other users via the social application 102.

At block 610, the social application 102 and/or the location matcher 120 of the server 106 can determine whether the user is at the selected venue, based on a comparison of the location of the user device relative to boundaries associated with the selected venue. For example, the social application 102 and/or the location matcher 120 of the server 106 can determine the location of the user device executing the social application 102, identify coordinates defining the boundaries associated with the selected venue, and determine whether the location of the user device is within the boundaries associated with the selected venue.

If the social application 102 and/or the server 106 determine that the user is not yet at the venue (Block 610 — No), the social application 102 and/or the server 106 can continue allowing the user to view user profile information of other users at the venue. However, once the social application 102 and/or the server 106 determine that user is at the venue (Block 610 — Yes), based on a comparison of the location of the user device relative to the boundaries of the selected venue, the social application 102 can check the user in to the venue and enable additional features and/or options associated with the venue within the social application 102.

For example, once the user has reached the venue and the user device is within the boundaries of the venue, at block 612 the social application 102 can enable options for the user to establish connections with, and/or otherwise interact with, other users who are also present at the venue and who are checked-in to the venue via the social application 102. For instance, the social application 102 can enable options to select a user profile of another user, establish a virtual connection between the user and the other user, buy items for the other user from the venue, exchange messages with the other user, and/or otherwise interact with the other user, for instance as described above with respect to FIG. 4 and FIG. 5.

At block 614, the social application 102 can determine whether the user has left the venue. In some examples, the social application 102 can determine that the user has left the venue based on a user selection of the leave option 132. In some situations, the user may select the leave option 132 to indicate that the user is planning to leave the venue, or otherwise desires to stop use of the social application 102 in association with the venue. In such cases, the social application 102 can consider the user to have left the venue and can check the user out of the venue, even if the user device is still located within the boundaries associated with the venue. In other examples, the social application 102 and/or the location matcher 120 of the server 106 can automatically determine that the user has left the venue based on a determination that coordinates of the user device have moved outside the boundaries associated with the venue.

If the social application 102 determines that the user has not yet left the venue (Block 614 — No), the social application 102 can continue to enable options for the user to establish connections with, and/or otherwise interact with, other users who are also present at the venue and who are checked-in to the venue via the social application 102. However, if the social application 102 determines that the user has left the venue (Block 614 — Yes), the social application 102 can disable such options at block 616. For example, if the user has left the venue, the social application 102 can disable options for the user to establish new connections, or interact with, other users at the venue that the user has not already connected with via the social application 102. As a non-limiting example, the social application 102 can disable or remove the “Say Hi” option 406 and the “Invite for a Drink” option 408 on profile pages of users who are still at the venue.

In some examples, if the user did establish a connection with another user present at the venue while connection options were enabled at block 612, those connections may remain accessible to the user after the user leaves the venue. For instance, if the user met another user via the social application 102 while both users were present at the venue, and established a corresponding virtual connection with the other user via the social application 102 using the “Say Hi” option 406 or the “Invite for a Drink” option 408, the social application 102 can keep the virtual connection accessible after the user and/or the other user leaves the venue. Accordingly, the users who established the virtual connection can use the social application 102 to exchange messages after the users have left the venue.

FIG. 7 shows a flowchart illustrating an example process 700 of a first user using the social application 102 to buy a drink from a venue for a second user. In example 700, both the first user and the second user can be present at the venue, and can have used the social application 102 to check-in to the venue as described above. For example, process 700 can occur while connections with other users, who also present at the venue, are possible at block 612 of FIG. 6.

At block 702, the first user can use the social application 102 to view a user profile of the second user. As discussed above with respect to FIG. 4, because both users are present at the same venue, options such as the “Say Hi” option 406 or the “Invite for a Drink” option 408 may be visible and selectable on the corresponding user profile page.

At block 704, the first user can select the “Invite for a Drink” option 408 on the second user’s profile page to offer to buy a drink for the second user from the venue. Selection of the “Invite for a Drink” option 408 can cause the instance of the social application 102 executing on a user device of the second user to present a corresponding drink offer notification. The second user can choose whether to respond to the drink offer notification. If the second user declines the drink offer (Block 706 — No), the first user may in some examples have the option of continuing to view the second user’s profile at block 702 or otherwise using the social application 102. In other examples, if the second user declines the drink offer (Block 706 — No), the social application 102 may block the first user from viewing the second user’s profile permanently or for a period of time.

However, if the second user accepts the drink offer (Block 706 — Yes), the social application 102 can determine at block 708 whether a POS system associated with the venue is integrated with the social application 102. The social application 102 may be integrated with the POS system because the social application 102 is configured to directly display a user interface of a virtual POS system used by the venue to place orders and process payments, or because the social application 102 can accept orders, bill users correspondingly, and re-place the orders via the POS system used by the venue.

If the social application 102 determines that the social application 102 is not integrated with a POS system used by the venue (Block 708 — No), the social application 102 can determine at block 710 whether the price of a drink at the venue, in some examples with the addition of a surcharge for the provider of the social application 102, is less than or equal to a maximum drink budget set by the first user. The social application 102 can base the price of the drink on an average price for a drink at the venue, a maximum price for a drink at the venue, a shared price for group of drinks or type of drink that can be selected in association with the drink offer, or any other price. As a non-limiting example, the first user can have set a maximum drink budget of $15 when the first user signed up for a user account with the social application 102, or can have set or adjusted the maximum drink budget after signing up for the user account. If the price of a drink at the venue is above the maximum drink budget set by the first user (Block 710 — Yes), or if the first user has not yet set a maximum drink budget, the social application 102 can notify the first user at block 712. The first user can accordingly choose whether or not to change settings to increase the maximum drink budget, and can choose to try extending the drink offer to the second user again.

If the social application 102 determines that the social application 102 is integrated with a POS system used by the venue (Block 708 — Yes), the social application 102 and/or the server 106 can receive a drink order from the second user at block 716. For example, an instance of the social application 102 executing on the user device of the second user can display a drink menu listing drinks available for purchase from the venue, and the social application 102 can accept user input from the second user selecting a particular drink. In some examples the drink menu can be displayed via a user interface of a virtual POS system used by the venue, and the second user can select the drink via the virtual POS system. In other examples the drink menu can be displayed via the social application 102, and the social application 102 can receive the second user’s selection of a drink order that the social application can later re-place via integration with the POS system used by the venue. In some examples, the drink menu displayed to the second user may limit drinks that can be selected by the second user to drinks that cost less than or equal to a maximum drink budget set by the first user as discussed above.

After receiving a drink order from the second user at block 716, or if the price of a drink at the venue does not exceed the maximum drink budget set by the first user (Block 71 2 — No), the social application 102,the server 106, and/or a corresponding payment system can attempt to process payment for the drink at block 714. In some examples, the first user can have stored credit card information or other payment information when the first user signed up for a user account with the social application 102, or can have set or adjusted the payment information after signing up for the user account. In other examples, the first user may have credit card information or other payment information stored with a POS system used by the venue or a third-party payment processor, or can enter payment information via the POS system or third-party payment processor. Accordingly, the social application 102, the server 1 06, or another payment system can use stored payment information associated with the first user to attempt to process the drink payment at block 714. The social application 102 or the server 106 can determine at block 718 whether the payment is successful.

If the payment fails (Block 718 — Yes), or if the first user has not provided payment information, the social application 102 can notify the first user at block 712. The first user can accordingly choose whether or not to change settings to provide payment information, and can choose to try extending the drink offer to the second user again. Although in some examples an error notification can be displayed to the first user at block 712 after the second user has accepted the drink offer at block 706 and/or after the second user has selected a drink order at block 716, in other examples such error notifications associated with drink budget settings, payment information, or other settings that may interrupt the drink buying process may be displayed to the first user prior to the drink offer being presented to the second user or at other stages of the process 700.

If the payment succeeds (Block 718 – No), the drink order for the second user can be processed at block 720. For example, if the social application 102 is configured to present a virtual POS system used by the venue and accepted the second user’s drink order via the virtual POS system at block 716, the venue can process the drink order received via the virtual POS system and provide the ordered drink to the second user. As another example, if the social application 102 received the second user’s drink order at block 716 and processed payment for the drink outside the POS system used by the venue, the social application 102 can use an API of the POS system to re-place the drink order via the POS system used by the venue. As yet another example, the social application 102 or the server 106 can generate a drink voucher for the second user at block 720. The drink voucher can have a value of the payment processed at block 714, such as a value that is less than or equal to a drink budget of the first user and/or a value of a particular drink selected by the second user. The drink voucher can be displayed via a notification to the second user via an instance of the social application 102 executing on a user device of the second user. The second user can accordingly have the option of redeeming the paid-for drink voucher with the venue. In some examples, redemption of the drink voucher with the venue can prompt a POS system, or other system associated with the venue, to notify the server 106 that the drink voucher has been redeemed.

At block 722, the social application 102 and/or the server 106 can establish a virtual connection between the first user and the second user, such that the first user and the second user can exchange messages via the social application 102. In some examples, the social application 102 and/or the server 106 may be configured to wait until the second user redeems a drink voucher with the venue before the virtual connection is established at block 722. In other examples, the social application 102 and/or the server 106 may establish the virtual connection at block 722 in response to the second user accepting the drink offer at 706, in response to the user providing a drink order at block 716, or at other stages of process 700, even if the second user has not yet redeemed a drink voucher or received an ordered drink.

Although FIG. 7 shows the first user purchasing a drink for a second user, in other examples the same process, or a similar process, can be followed for the first user to buy any other type of item, such as food or non-food items, for a second user from a venue. As an example, the first user may select an option via the social application 102 to offer to buy a different type of item from the venue for the second user. A corresponding item purchase offer can be displayed to the second user via the social application 102, and the second user can choose whether or not to accept the item purchase offer. Acceptance of the item purchase offer by the second user can cause a corresponding payment to be processed from a payment account associated with the first user, generation of an item purchase voucher, and/or display of a menu of items available for purchase from the venue that the second user can select from in association with the item purchase offer.

FIG. 8 shows an example 800 in which users can participate in private groups via the social application 102. Private groups can be associated with particular businesses, venues, or other entities. Such entities can use the business portal 118 to set up and/or manage private groups. As example, a business can establish a private group within the social application 102 for employees of the business. As another example, a hotel can establish a private group within the social application 102 for guests of the hotel.

At block 802, a user can be invited to a private group. In some examples, an entity that manages the private group may give the user an access code, QR code, or other authorization code associated with the private group. The user can use the provided code to join the private group as discussed further below. In other examples, the entity that manages the private group can use the business portal 118 to enter an email address, phone number, or other contact information of the user. In response to entry of the contact information, the server 106 can send an email, a text message, or other notification or message to the user that invites the user to the private group. The message sent by the server 106 can include an access code that the user can use to join the private group. The access code may, in some examples, be a one-time use code that is specific to the user and is generated by the server 106. If the user is not already a user of the social application 102, the message sent by the server 106 may also include instructions and/or links that the user can use to download the social application 102 and sign up for a user account by providing user profile data 108.

At block 804, the server 106 can determine whether the user joined the private group. For example, if the user was invited to the private group outside of the business portal 118 by being given an access code, QR code, or other authorization code associated with the private group, the user may navigate in the social application 102 to a private group authorization section of a settings menu. In the private group authorization section, the user may enter a provided code, scan a provided QR code, or otherwise provide information that causes the user to join the private group in the social application 102. As another example, if the server 106 sent an invitation message to the user that included an access code, the user may select a link in the invitation message that is associated with the access code to automatically join the private group or can enter the access code in the social application 102 via the private group authorization section of the settings menu as discussed above.

If the user does not join the private group (Block 804 — No), the process 800 may end or the user can be invited to the private group at block 802 again. However, if the user does join the private group (Block 806 — Yes), the social application 102 and/or the server 106 can enroll the user in the private group at block 806. For example, the social application 102 and/or the server 106 can add a private group identifier or other data to the user profile data 108 of the user to indicate that the user is a member of the private group. The user profile data 108 can also include other information that is not associated with the private group, as discussed above.

At block 808, the social application 102 can display private group information, associated with the private group, to the user. As an example, because the member has joined the private group, the map 302 shown in FIG. 3 may display user icons 306 indicating locations of other members of the private group that are checked-in to venues displayed on the map 302. Similarly, user profiles for other members of the private group may be highlighted, flagged, or otherwise noted in the view shown in FIG. 1 that displays information about other users who are checked-in to a venue.

As another example, the social application 102 may display venue icons 304 on the map 302 shown in FIG. 3 for private venues that are associated with the private group. Accordingly, users who are members of the private group can check-in to a corresponding private venue to meet other members of the private group in-person, establish virtual connections with other members of the private group via the social application 102, buy drinks or other items for other members of the private group, and/or use other features described herein in association with other members of the private group.

A venue may be marked as private and associated with a particular venue in the business portal 118. In some examples, such a venue may be publicly accessible, but the social application 102 may place restrictions on the venue such that only members of the private group can check-in to the venue via the social application 102. In these examples, other users who are not members of the private group may be able to physically visit the venue, but may be unable to check-in to the venue via the social application 102. In other examples, the venue may only allow members of the private group to physically enter the venue, for instance based the members of the private group displaying a QR code or other venue access code via the social application 102.

As discussed above, in some examples a business may set up a private group in the social application 102 for employees of the business. In these examples, the business may designate office locations as private venues. Accordingly, employees who have joined the private group can check-in to the office locations via the social application 102 when user devices of the employees are physically present at the office locations. Other employees who have also joined the private group can accordingly use the social application 102 to see which other employees are checked-in to an office location via the social application 102. For instance, an employee may use the social application 102 and see that a group of co-workers has checked-in to an office location on a particular day, and based on that information the employee may choose to travel to the office location for work on that particular day instead of working from home.

The business may also use the business portal 118 to send notifications via the social application 1 02 to members of the private group about office events, happy hours, and/or other events. For example, the business may send a notification indicating that an office happy hour will be going on at a particular time at a particular venue outside the office. Members of the private group can use the social application 102 to see which other members of the private group are at the happy hour at the particular venue, indicate that they are on the way to the happy hour, and/or use other features described herein.

Other types of private groups may accept other types of members. For example, a hotel may invite guests to join a private group for guests of the hotel during their stay at the hotel. The hotel may use the business portal 118 to send invitations to the private group before guests arrive and check in to the hotel, and/or may provide guests with instructions and access codes for joining the private group upon the guests checking in to the hotel. The hotel may also use the business portal 118 to designate one or more portions of the hotel, such as particular bars or restaurants, as private venues associated with the private group. Accordingly, guests of the hotel who have joined the private group can check-in to private venues at the hotel via the social application 102. Guests of the hotel who have joined the private group can also view user profiles of other guests who have joined the private group in order to meet the other guests in-person, establish virtual connections with other guests via the social application 102, buy drinks or other items for other guests, and/or use other features described herein in association with other guests who have joined the private group.

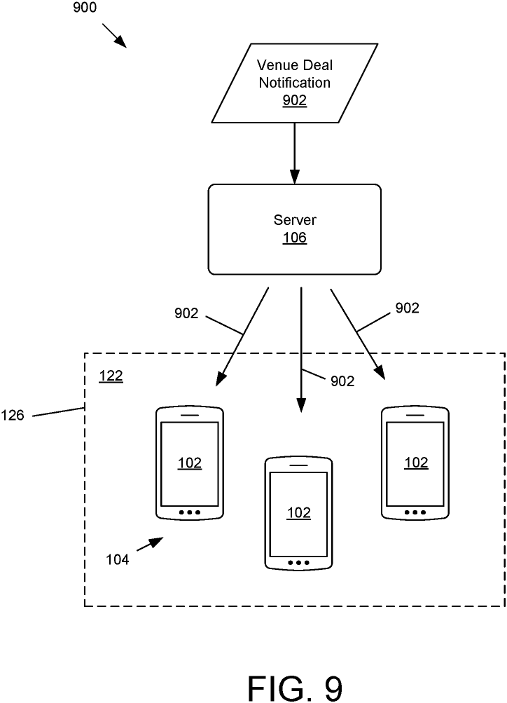

FIG. 9 shows an example 900 in which the server 106 can transmit venue deal notifications to instances of the social application 102. As discussed above, instances of the social application 102 executing on user devices 104, and/or the server 106, may check users in to a venue while coordinates of the user devices 104 are within the boundaries 126 associated with the venue. In some examples, users can use the social application 102 to purchase drinks or other items from the venue for other users who are present at the venue, as discussed above. However, in some examples, the venue can also, or alternately, provide venue deal notifications to users who are present and checked-in to the venue of the social application 102.

For example, user devices 104 may be present within boundaries 126 of venue 122 as shown in FIG. 9. The user devices 104 may be executing instances of the social application 102, such that the social application 102 checks corresponding user profiles in to the venue 122 based on the user devices 104 being present within the boundaries 1 26, as discussed above. The server 106 may track which user profiles are checked-in to the venue 122. The server 106 may also receive a venue deal notification 902 from a computing device associated with the venue, such as computer or mobile device associated with an owner or operator of the venue 122. In some examples, the owner or operator of the venue 122 may use such a computer or mobile device to access the business portal 118, and enter details about the venue deal notification 902 via the business portal 118. The venue deal notification 902 may indicate free items, reduced-price items, and/or other deals associated with items for sale at the venue 122. The server 106 can transmit the venue deal notification 902 to the instances of the social application 102 that are checked-in at the venue 122 and that are executing on the user devices 104 present within the boundaries 126 of the venue 122.

In some examples, the venue deal notification 902 can be associated with a private group or a social circle. For instance, if the venue deal notification 902 is associated with a particular private group, members of the private group who are checked-in to the venue may receive the venue deal notification 902 via the social application 102, but other users of the social application 102 who are checked-in to the venue may not receive the venue deal notification 902. In some examples, members of a private group may receive different venue deal notifications than other users who are not members of the private group, such as venue deal notifications for different items or that have deeper discounts.

Users of the social application 102 at the venue 122 that receive the venue deal notification 902 can have the option of using or redeeming the corresponding deal with the venue 122. In some examples, a user can use the deal by selecting an option presented in the social application 102 in association with the venue deal notification 902, for instance to purchase an item from the venue 122 at a reduced price indicated by the venue deal notification 902. Such a purchase may be implemented via payment information stored in user profile data 108 associated with the user, via a POS system associated with the venue 122, via a third-party payment system, and/or other systems. In other examples, the user may show a barcode, QR code, numerical code, or other deal indication in the venue deal notification 902 to a bartender, cashier, or other worker at the venue 122 to purchase an item from the venue 122 at a reduced price indicated by the venue deal notification 902. In some examples, if a user purchases an item from the venue 122 based on the venue deal notification 902, the venue 122 and a provider of the social application 102 may share portions of the proceeds of the purchase.

By sending the venue deal notification 902 associated with the venue 122 to instances of the social application 102 executing on user devices 104 known to be present within the boundaries 126 of the venue 122, the response rate to the venue deal notification 902 may be higher than to other forms of marketing. For example, rather than sending email advertisements to a large group of potential customers, most of which may be unlikely to actually visit the venue on a particular day, the venue deal notification 902 can be provided to users that have already checked-in to the venue 122 via the social application 102 and may therefore be more likely to make purchases at the venue 122.

Sending the venue deal notification 902 to such checked-in users of the social application 102 can also reduce bandwidth usage and usage of other computing resources, relative to conventional email marketing campaigns or other forms of communications. For instance, instead of the venue 122 sending hundreds or thousands of emails about a deal to a large set of potential customers, a smaller amount of venue deal notifications can be sent via the server 106 to instances of the social application 102 executing on a set of user devices 104 that are already physically present at the venue 122. This can reduce usage of bandwidth over networks to transmit the venue deal notifications relative to sending a larger set of emails, and reduce usage of processor cycles, memory, and/or other computing resources relative to sending a larger set of emails.

In some examples, the venue deal notification 902 can be integrated with options for users to purchase items from the venue for other users. For example, if two users establish a connection via the social application 102 while the users are present at the venue, the social application 102 can provide an option for one user to buy the other user a drink, or another item, from the venue via the social application 102, as described above. In some examples, the venue deal notification 902 may relate to items that users buy for other users via such an option, or the venue may provide customized or targeted venue deal notifications for specific pairs of users of if a user has initiated a process to buy an item for another user.

In some examples, venue deal notifications can be provided to a set of users who use the social application 102 most often. For instance, the server 106 may track “power users” who have beyond a threshold number of check-ins to the venue 122 and/or other venues, and may provide the venue deal notification 902, or a different specialized venue deal notification, associated with the venue 122 just to “power users” who are checked-in to the venue 122. The server 106 may, in some examples, provide venues with reports about power users, numbers of users who have received and/or used venue deal notifications, and/or other metrics associated with users.

In some examples, the venue deal notifications can also be provided to users who have selected the “Invite for a Drink” option 408 on profile pages of other users, such that the users can buy such drinks from the venue at reduced prices. In other examples, the venue deal notifications can also be provided to users in association with the “Invite for a Drink” option 408, to entice the users to opt to buy drinks for other users at reduced prices.

FIG. 10 shows an example of system architecture for a user device 1000, in accordance with various examples. The user device 1000 can be one of the user devices 104 described above, such as user device 104A or user device 104B. The user device 1000 can have memory 1002 storing the social application 102 and other modules and data 1004. The user device 1000 can also have processor(s) 1006, transmission interfaces 1008, location determiners 1010, a display 1012, output devices 1014, input devices 1016, and/or a drive unit 1018 including a machine readable medium 1020.

In various examples, the memory 1002 can include system memory, which may be volatile (such as RAM), non-volatile (such as ROM, flash memory, etc.) or some combination of the two. The memory 1002 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory comptiter-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information and which can be accessed by the user device 1000. Any such non-transitory computer-readable media may be part of the user device 1000.

The memory 1002 can include one or more software or firmware elements, such as computer-readable instructions that are executable by the one or more processors 1006. For example, the memory 1002 can store computer-executable instructions and/or other data associated with the social application 102. The memory can also store other modules and data 1004, such as a platform, operating system, firmware, and/or applications, and data utilized by the platform, operating system, firmware, and/or applications.

In various examples, the processor(s) 1006 can be a central processing unit (CPU), a graphics processing unit (GPU), or both CPU and GPU, or any other type of processing unit. Each of the one or more processor(s) 1006 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 1006 may also be responsible for executing all computer applications stored in the memory 1002, which can be associated with types of volatile (RAM) and/or nonvolatile (ROM) memory.

The transmission interfaces 1008 can include transceivers, modems, interfaces, antennas, and/or other components that perform or assist in exchanging radio frequency (RF) communications or other types of communications with base stations of a cellular access network, Wi-Fi® access points, and/or otherwise implement connections with one or more networks. The transmission interfaces 1008 can be used by the social application 102 to exchange data with the server 106.

The location determiners 1010 can include GPS components, cellular triangulation components, and/or other elements that can determine coordinates of the location of the user device 1000. As described above, such coordinates can be used by the social application 102 and/or the server 106 to determine whether the user device 1000 is located within boundaries associated with a venue.

The display 1012 can be a liquid crystal display or any other type of display commonly used in user devices. For example, the display 1012 may be a touch-sensitive display screen, and can thus also act as an input device or keypad, such as for providing a soft-key keyboard, navigation buttons, or any other type of input.

The output devices 1014 can include any sort of output devices known in the art, such as the display 1012, speakers, a vibrating mechanism, and/or a tactile feedback mechanism. Output devices 1014 can also include ports for one or more peripheral devices, such as headphones, peripheral speakers, and/or a peripheral display.

The input devices 1016 can include any sort of input devices known in the art. For example, input devices 1016 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 1020 can store one or more sets of instructions, such as software or firmware, that embodies any one or more of the methodologies or functions described herein. The instructions can also reside, completely or at least partially, within the memory 1002, processor(s) 1006, and/or transmission interface(s) 1008 during execution thereof by the user device 1000. The memory 1002 and the processor(s) 1006 also can constitute machine readable media 1020.

FIG. 11 shows an example of system architecture 1100 for a computing system 1102 associated with the server 106. The computing system 1102 can include the server 106 and/or other computing elements that execute one or more backend elements associated with the social application 102 and/or store data associated with the social application 102. For example, the computing system 1102 can store data and/or computer-executable instructions associated with the user profile data 108, the venue data 110, the business portal 118, the location matcher 120, and/or other elements described herein. The computing system 1102 can include one or more computers, servers, or other types of computing devices. Individual computing devices of the computing system 1102 may have the system architecture 1100 shown in FIG. 11, or a similar system architecture.

In some examples, backend elements associated with the social application 102 can be distributed among, and/or be executed by, multiple computing systems or devices similar to the computing system 1102 shown in FIG. 11. For instance, in some examples, the location matcher 120 may execute on a different computing device than computing devices that store the user profile data 108 and/or the venue data 110. The computing system 1102 may, in some examples, be part of a cloud computing environment or other distributed system that hosts and/or executes one or more backend elements associated with the social application 102 and/or other elements described herein.

The computing system 1102 can include memory 1104. In various examples, the memory 1104 can include system memory, which may be volatile (such as RAM), non-volatile (such as ROM, flash memory, etc.) or some combination of the two. The memory 1104 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing system 1102. Any such non-transitory computer-readable media may be part of the computing system 1102.

The memory 1104 can store one or more software or firmware elements, such as data and/or computer-readable instructions that are executable by one or more processors 1108. For example, the memory 1104 can store computer-executable instructions and data associated with the social application 102, such as computer-executable instructions and data associated with the user profile data 108, the venue data 110, the business portal 118, and/or the location matcher 120. The memory 1104 can also store other modules and data 1106, such as any modules and/or data that can be utilized by the computing system 1102 to perform or enable performing any action taken by the computing system 1102. Such modules and data 1106 can include a platform, operating system, and applications, and data utilized by the platform, operating system, and applications.

The computing system 1102 can also have processor(s) 1108, communication interfaces 1110, a display 1112, output devices 1114, input devices 1116, and/or a drive unit 1118 including a machine readable medium 1120.

In various examples, the processor(s) 1108 can be a CPU, a GPU, both a CPU and a GPU, or any other type of processing unit. Each of the one or more processor(s) 1108 may have numerous ALUs that perform arithmetic and logical operations, as well as one or more CUs that extract instructions and stored content from processor cache memory, and then executes these instructions by calling on the ALUs, as necessary, during program execution. The processor(s) 1108 may also be responsible for executing computer applications stored in the memory 1104, which can be associated with types of volatile (RAM) and/or nonvolatile (ROM) memory.

The communication interfaces 1110 can include transceivers, modems, network interfaces, antennas, and/or other components that can transmit and/or receive data over networks or other connections. In some examples, the communication interfaces 1110 can be used to exchange data with instances of the social application 102 executing on user devices 104 as described herein.

The display 1112 can be a liquid crystal display, or any other type of display commonly used in computing devices. For example, a display 1112 may be a touch-sensitive display screen, and can then also act as an input device or keypad, such as for providing a soft-key keyboard, navigation buttons, or any other type of input.

The output devices 1114 can include any sort of output devices known in the art, such as the display 1112, speakers, a vibrating mechanism, and/or a tactile feedback mechanism. Output devices 1114 can also include ports for one or more peripheral devices, such as headphones, peripheral speakers, and/or a peripheral display.

The input devices 1116 can include any sort of input devices known in the art. For example, input devices 1116 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 1120 can store one or more sets of instructions, such as software or firmware, that embodies any one or more of the methodologies or functions described herein. The instructions can also reside, completely or at least partially, within the memory 1104, processor(s) 1108, and/or communication interface(s) 1110 during execution thereof by the computing system 1102. The memory 1104 and the processor(s) 1108 also can constitute machine readable media 1120.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computer-implemented method, comprising:
determining, by one or more processors, and based on first location data associated with a first user device executing a social application, that the first user device is located within boundaries associated with a venue, wherein the first user device is associated with a first user of the social application;
identifying, by the one or more processors, a set of other users of the social application present at the venue, based on second location data associated with user devices of the set of other users indicating that the user devices are within the boundaries associated with the venue;
causing, by the one or more processors, a user interface of the social application executing on the first user device to present at least a portion of user profile data associated with the set of other users present at the venue; and
enabling, by the one or more processors, and based on determining that the first user device is located within the boundaries, one or more options within the social application to initiate a social connection between the first user and a second user within the set of other users present at the venue.

2. The computer-implemented method of claim 1, further comprising:
disabling, by the one or more processors, the one or more options within the social application in response to at least one of:
a user selection, by the first user, of a leave option associated with the venue, or
a determination that the first location data indicates that the first user device is located outside the boundaries associated with the venue.

3. The computer-implemented method of claim 1, wherein:
the one or more options include an option to establish a virtual connection between the first user and the second user via the social application,
selection of the option by the first user, via the social application executing on the first user device, causes a corresponding notification to be displayed via the social application on a second user device associated with the second user, and
a response from the second user to the corresponding notification indicates an acceptance or denial of the virtual connection.

4. The computer-implemented method of claim 1, wherein:
the one or more options includes an option for the first user to offer, via the social application, to buy an item from the venue for the second user,
selection of the option by the first user, via the social application executing on the first user device, causes a corresponding notification of an item purchase offer to be displayed via the social application on a second user device associated with the second user, and
a response from the second user to the corresponding notification indicates an acceptance or denial of the item purchase offer.

5. The computer-implemented method of claim 4, further comprising:
generating, by the one or more processors, an item redemption voucher based on:
the response indicating that the second user accepts the item purchase offer; and
processing of a payment for the item redemption voucher from a payment account associated with the first user,
wherein the item redemption voucher is configured to be displayed via the social application on the second user device, and is redeemable by the second user with the venue to purchase the item.

6. The computer-implemented method of claim 4, further comprising:
determining, by the one or more processors, that the response indicates that the second user accepts the item purchase offer;
causing, by the one or more processors, a menu of items available for purchase from the venue to be displayed to the second user via the social application executing on the second user device;
receiving, by the one or more processors, and via the social application executing on the second user device, a selection of the item based on user input provided by the second user; and
causing, by the one or more processors, a payment associated with the item purchase offer to be processed.

7. The computer-implemented method of claim 1, further comprising:
causing, by the one or more processors, the social application executing on the first user device to display a map of a plurality of venues,
receiving, by the one or more processors, and via the social application executing on the first user device, a selection of the venue from the map by the first user;
receiving, by the one or more processors, and via the social application, an indication that the first user is en route to the venue; and
causing, by the one or more processors, the social application executing on the first user device to present the at least the portion of the user profile data associated with the set of other users present at the venue in response to at least one of:
the selection of the venue, or
the indication that the first user is en route to the venue.

8. The computer-implemented method of claim 7, further comprising:
disabling, by the one or more processors, the one or more options while the first user is en route to the venue and the first location data associated with the first user device indicates that the first user device is located outside the boundaries associated with the venue, and
enabling, by the one or more processors, the one or more options based on the first location data indicating that the first user device has entered the boundaries associated with the venue.

9. The computer-implemented method of claim 1, wherein:
the user profile data indicates social goal information associated with the set of other users, and
the user interface of the social application presents, based on the social goal information, visual indicia of one or more corresponding social goals of individual users in the set of other users.

10. The computer-implemented method of claim 1, wherein:
the user profile data indicates social passwords associated with the set of other users,
the social passwords are selected by individual users, in the set of other users, and express interests of the individual users, and
the user interface of the social application presents the social passwords associated with the set of other users.

11. The computer-implemented method of claim 1, further comprising:
receiving, by the one or more processors, a venue deal notification associated with the venue, wherein the venue deal notification is associated with an exclusive deal for users of the social application who are present at the venue; and
the user interface of the social application presents the venue deal notification to the first user based on determining that the first user device is located within the boundaries associated with the venue.

12. The computer-implemented method of claim 1, wherein:
the first user is enrolled in a private group via the social application,
the set of other users is a set of members of the private group, and
the venue is designated, via a business portal associated with the social application, as a private venue for members of the private group.

13. The computer-implemented method of claim 12, wherein the business portal is configured to allow a business associated with the venue to at least one of:
manage the private group,
designate venues, in a plurality of venues associated with the business, as public venues available to any user of the social applications or as private venues available to members of the private group or other private groups,
invite users of the social application to join the private group,
generate an access code that is usable by the users of the social application to join the private group, or
send, via the social application, notifications to the set of members of the private group.

14. The computer-implemented method of claim 12, further comprising:
causing, by the one or more processors, the social application executing on the first user device to display a map of a plurality of venues that includes:
one or more public venues available to any user of the social application; and
one or more private venues, including the private venue, available to the members of the private group or other private groups in which the first user is enrolled.

15. A user device, comprising:
one or more processors; and
memory storing computer-executable instructions associated with a social application that, when executed by the one or more processors, cause the one or more processors to perform operations comprising:
determining, based on first location data associated with the user device, that the user device is located within boundaries associated with a venue, the user device being associated with a first user of the social application;
identifying a set of other users of the social application present at the venue, based on second location data associated with user devices of the set of other users indicating that the user devices are within the boundaries associated with the venue,
displaying, within a user interface of the social application, at least a portion of user profile data associated with the set of other users present at the venue; and
enabling an option, within the social application, and based on determining that the user device is located within the boundaries, for the first user to initiate a social connection with a second user within the set of other users present at the venue.

16. The user device of claim 15, wherein:
the option allows the first user to offer, via the social application, to bily an item from the venue for the second user,
selection of the option by the first user, via the social application, causes a corresponding notification of an item purchase offer to be displayed via an instance of the social application on a second user device associated with the second user, and
a response from the second user to the corresponding notification indicates an acceptance or denial of the item purchase offer.

17. The user device of claim 15, wherein the operations further comprise:
displaying, via the social application, a map of a plurality of venues,
receiving, via the social application, a selection of the venue from the map by the first user;
receiving, via the social application, an indication that the first user is en route to the venue; and
presenting, via the social application, the at least the portion of the user profile data associated with the set of other users present at the venue in response to at least one of
the selection of the venue, or
the indication that the first user is en route to the venue.

18. One or more non-transitory computer-readable media storing computer-executable instructions associated with a social application that, when executed by one or more processors of a user device associated with a first user of the social application, cause the one or more processors to:
determine, based on first location data associated with the user device, that the user device is located within boundaries associated with a venue;
identify a set of other users of the social application present at the venue, based on second location data associated with user devices of the set of other users indicating that the user devices are within the boundaries associated with the venue;
display, within a user interface of the social application, at least a portion of user profile data associated with the set of other users present at the venue; and
enabling an option, within the social application, and based on determining that the user device is located within the boundaries, for the first user to initiate a social connection with a second user within the set of other users present at the venue.

19. The one or more non-transitory computer-readable media of claim 18, wherein:
the option allows the first user to offer, via the social application, to buy an item from the venue for the second user,
selection of the option by the first user, via the social application, causes a corresponding notification of an item purchase offer to be displayed via an instance of the social application on a second user device associated with the second user, and
a response from the second user to the corresponding notification indicates an acceptance or denial of the item purchase offer.

20. The one or more non-transitory computer-readable media of claim 18, wherein computer-executable instructions further cause the one or more processors to:
display, via the social application, a map of a plurality of venues;
receive, via the social application, a selection of the venue from the map by the first user;
receive, via the social application, an indication that the first user is en route to the venue; and
present, via the social application, the at least the portion of the user profile data associated with the set of other users present at the venue in response to at least one of:
the selection of the venue, or
the indication that the first user is en route to the venue.
